(19) United States
(12) Patent Application Publication
(10) Pub. No.: US 2026/0051173 A1
(43) Pub. Date: Feb. 19, 2026

(54) Visual pick validation

(71) Applicant: FLYMINGO INNOVATIONS LTD., Kiryat Ono (IL)

(72) Inventors: Roy Gherman, Kiryat Ono (IL); Itzik Mizrahi, Maccabim-Re’ut (IL); Gal Fiebelman, Manof (IL); Shahar Korin, Tel Aviv (IL)

(21) Appl. No.: 19/102,432

(22) PCT Filed: Aug. 22, 2023
(86) PCT No.: PCT/IB2023/058346

§ 371 Date: Feb. 10, 2025

Related U.S. Application Data
(60) Provisional application No. 63/400,058, filed on Aug. 23, 2022.

(51) Int. Cl. G06V 20/52; G06Q 10/087; G06T 11/20; G06V 10/10; G06V 10/12; G06V 20/40; G06V 40/10; G06V 40/20

(52) U.S. Cl. CPC G06V 20/52; G06Q 10/08741; G06T 11/206; G06V 10/12; G06V 10/16; G06V 20/41; G06V 40/10; G06V 40/20

(57) ABSTRACT

A method, including collecting overlapping video segments (36) that cover a warehouse (20) storing items (22) in respective bins (24), and stitching together the videos so as to generate a merged video (54). In the merged video, individuals (38) are identified performing picking actions (144) from different bins at respective coordinates (146), and based on the merged video, respective coordinates (84) of the bins from which the picking actions were performed are identified. A set of orders are retrieved from a warehouse management system (86), each of the first orders performed by a given individual and including one or more of the items. The picking actions, the coordinates of the bins, and the first orders are analyzed so as to establish a correspondence between the bins and the items, and the correspondence is applied to verify execution of second orders performed subsequent to performance of the set of first orders.

### CROSS-REFERENCE TO RELATED APPLICATIONS

This application claims the benefit of U.S. Provisional Patent Application 63/400,058, filed Aug. 23, 2022, which is incorporated herein by reference.

### FIELD OF THE INVENTION

The present invention relates generally to computer image recognition, and particularly to using image recognition to verify fulfillment of picklists in a distribution center.

### BACKGROUND OF THE INVENTION

A Warehouse Management System (WMS) is a software application or platform that helps businesses efficiently manage and control their distribution center operations. It can serve as a central hub for overseeing all the activities involved in the storage, movement, and tracking of inventory within a distribution center (i.e., a warehouse). Key features of a Warehouse Management System typically include:
Inventory Management: Tracking and managing the location, quantity, and status of all items in the warehouse. This includes receiving, put-away, picking, packing, and shipping of goods.
Order Management: Processing and optimizing orders, ensuring timely fulfillment, and prioritizing tasks to meet customer demands.
Real-time Tracking: Providing real-time visibility into inventory levels, order status, and overall warehouse performance, allowing for better decision-making and proactive problem-solving.
Automated Workflows: Automating various warehouse processes, such as order fulfillment, picking routes, and replenishment, to improve efficiency and reduce errors.
Labor Management: Monitoring and optimizing workforce productivity, including performance tracking, task allocation, and labor scheduling.
Reporting and Analytics: Generating comprehensive reports and data analytics to analyze warehouse performance, identify trends, and make informed business decisions.

The implementation of a Warehouse Management System can lead to numerous benefits, such as increased operational efficiency, reduced inventory carrying costs, improved order accuracy, enhanced customer service, and better utilization of warehouse space. It is particularly valuable for businesses dealing with high-volume inventory, complex supply chains, and the need for precision in order fulfillment processes.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method including collecting a set of overlapping video segments that cover a warehouse storing multiple items in respective bins, stitching together the video segments so as to generate a merged video image sequence in a coordinate system of the warehouse, identifying, in the merged video image sequence, multiple individuals performing picking actions from different ones of the bins at respective coordinates in the coordinate system, computing, based on the merged video image sequence, respective coordinates in the coordinate system of the bins from which the picking actions were performed, retrieving, from a warehouse management system, a set of first work orders, each of the first work orders performed by a given individual and comprising one or more of the items, analyzing, by a processor, the picking actions, the coordinates of the bins, and the first work orders so as to establish a correspondence between the bins and the items, and applying the correspondence in verifying execution of second work orders performed subsequent to performance of the set of first work orders.

In one embodiment, the video cameras have respective fields of view (FOV), and where the fields of view of pairs of the cameras that are adjacent to one another have an overlap between 10% and 30%.

In some embodiments, the video segments include respective video segment frames with corresponding timestamps, wherein the merged video sequence includes merged videoframes, and wherein stitching together the video segments includes identifying a first video segment frame from a first video camera in a given pair of the cameras, identifying a second video segment frame from a second video camera in the given pair of the cameras having an identical timestamp to first video segment frame, and applying an homography algorithm to the identified video segment frames so as to generate a given merged video frame.

In another embodiment, collecting a given video segment includes receiving a video signal, generating, in response to receiving the signal, the given video segment at a first frames per second (FPS) upon detect motion in the video signal, and generating the given video segment at a second FPS lower than the first FPS upon not detect motion in the video signal.

In an additional embodiment, a given picking action includes retrieving one or more given items.

In a further embodiment, a given picking action includes restocking one or more given items.

In a supplemental embodiment, a given picking action includes dropping one or more given items.

In one embodiment, computing the respective coordinates of the bins includes generating a heat map of the coordinates of the picking action, and detecting, clusters of the coordinates in the heat map, wherein the clusters correspond to the bins.

In some embodiments, generating the heat map includes applying a clustering algorithm to the coordinates of the picking action so as to generate the detected clusters.

In a clustering embodiment, computing the respective coordinates of a given bin includes applying a convex function to the coordinates in the corresponding cluster.

In another embodiment, establishing the correspondence between the bins and the items includes applying a majority voting algorithm to the picking actions, the coordinates of the bins, and the first work orders.

In an additional embodiment, verifying execution of a given second work order includes generating an alert upon detecting, based on the established correspondence, a picking error for a given item in the work order.

In some embodiments, the method further includes updating the corresponding bin for the given item upon receiving an override for the alert.

In a further embodiment, the merged video image sequence covers all the bins.

In a supplemental embodiment, wherein a given bin includes a workstation configured to generate the work orders.

In some embodiments, a given picking action includes retrieving a given work order from the workstation.

There is also provided, in accordance with an embodiment of the present invention, an apparatus including a memory, and a processor configured to collect a set of overlapping video segments that cover a warehouse storing multiple items in respective bins, to stitching together the video segments so as to generate, in the memory, a merged video image sequence in a coordinate system of the warehouse, to identify, in the merged video image sequence, multiple individuals performing picking actions from different ones of the bins and at respective coordinates in the coordinate system, to compute, based on the merged video image sequence, respective coordinates in the coordinate system of the bins from which the picking actions were performed, to retrieve, from a warehouse management system, a set of first work orders, each of the first work orders performed by a given individual and comprising one or more of the items, to analyze the picking actions, the coordinates of the bins, and the first work orders so as to establish a correspondence between the bins and the items, and to apply the correspondence in verifying execution of second work orders performed subsequent to performance of the set of first work orders.

There is additionally provided, in accordance with an embodiment of the present invention, a computer software product, the product comprising a non-transitory computer-readable medium, in which program instructions are stored, which instructions, when read by a computer, cause the computer to collect a set of overlapping video segments that cover a warehouse storing multiple items in respective bins, to stitch together the video segments so as to generate a merged video image sequence in a coordinate system of the warehouse, to identify, in the merged video image sequence, multiple individuals performing picking actions from different ones of the bins at respective coordinates in the coordinate system, to compute, based on the merged video image sequence, respective coordinates in the coordinate system of the bins from which the picking actions were performed, to retrieve, from a warehouse management system, a set of first work orders, each of the first work orders performed by a given individual and comprising one or more of the items, to analyze the picking actions, the coordinates of the bins, and the first work orders so as to establish a correspondence between the bins and the items, and to apply the correspondence in verifying execution of second work orders performed subsequent to performance of the set of first work orders.

### BRIEF DESCRIPTION OF THE DRAWINGS

The disclosure is herein described, by way of example only, with reference to the accompanying drawings, wherein:

FIG. 1 is a schematic pictorial illustration showing an example of a distribution center comprising items stored in bins, a set of video cameras, and a verification engine that is configured to using image processing to verify order fulfillment, in accordance with an embodiment of the present invention;

FIG. 2 is a block diagram that shows an example of a configuration of the verification engine comprising a warehouse management system, in accordance with an embodiment of the present invention;

FIG. 3 is a block diagram showing an example of an inventory record managed by the warehouse management system, in accordance with an embodiment of the present invention;

FIG. 4 is a block diagram showing an example of an order record managed by the warehouse management system, in accordance with an embodiment of the present invention;

FIG. 5 is a block diagram showing an example of a picklist managed by the warehouse management system, in accordance with an embodiment of the present invention;

FIG. 6 is a block diagram showing an example of a pick record managed by the warehouse management system, in accordance with an embodiment of the present invention;

FIG. 7 is a flow diagram that schematically illustrates a method of mapping the items to their respective bins, in accordance with an embodiment of the present invention;

FIG. 8 is an example of overlapping video segment images captured by the video cameras, in accordance with an embodiment of the present invention;

FIG. 9 shows the overlapping video segment images stitched together, in accordance with an embodiment of the present invention;

FIGS. 10A-10C, also referred to herein collectively as FIG. 10 are pictorial illustrations of a first picking action, in accordance with an embodiment of the present invention;

FIGS. 11A-11C, also referred to herein collectively as FIG. 1 are pictorial illustrations of a second picking action, in accordance with an embodiment of the present invention;

FIG. 12 is a pictorial illustration of a video segment showing individuals picking orders, in accordance with an embodiment of the present invention;

FIG. 13 is a pictorial illustration of a heat map generated from picking actions performed by the individuals, in accordance with an embodiment of the present invention;

FIG. 14 is a pictorial illustrations showing bin coordinates computed based on the heat map, in accordance with an embodiment of the present invention; and

FIG. 15 is a flow diagram that schematically illustrates a method of verifying picking actions performed by the individuals, in accordance with an embodiment of the present invention.

### DETAILED DESCRIPTION OF EMBODIMENTS

Since orders in distribution centers are typically processed by humans, there may be picking mistakes when processing the orders simply as a result of human error. One example of these mistakes is a picking action error (e.g., picking from a wrong location and/or picking a wrong quantity).

Embodiments of the present invention provide methods and systems for identifying mappings of items to bins in a distribution center. As described hereinbelow, a set of overlapping video segments that cover a warehouse storing multiple items in respective bin are collected, and the video segments are stitched together so as to generate a merged video image sequence in a coordinate system of the warehouse. In the merged video image sequence, multiple individuals performing picking actions from different ones of the bins at respective coordinates in the coordinate system are identified, and based on the merged video image sequence, respective coordinates in the coordinate system are computed for the bins from which the picking actions were performed. A set of first work orders are retrieved from a warehouse management system, each of the first work orders performed by a given individual and comprising one or more of the items. Finally, the picking actions, the coordinates of the bins, and the first work orders are analyzed so as to establish a correspondence between the bins and the items.

Additional embodiments of the present invention provide methods and systems to use the established correspondence (i.e., mappings) to detect any orders in second work orders picked by the individuals. In these embodiments, the established correspondence is applied so as to verify execution of second work orders performed subsequent to performance of the set of first work orders.

### System Description

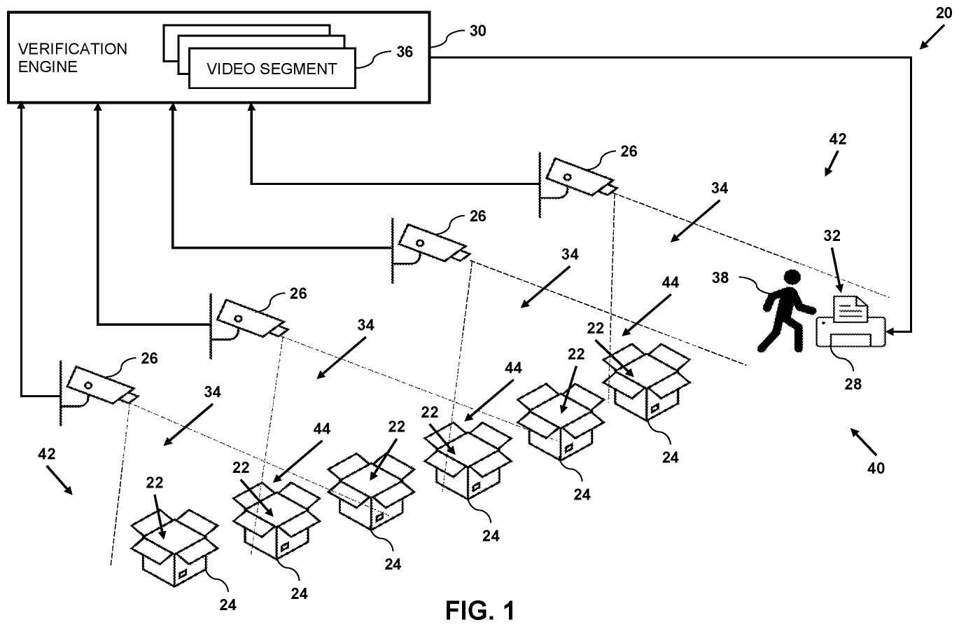

FIG. 1 is a schematic pictorial illustration showing an example of a distribution center 20 (also referred to herein as warehouse 20) comprising multiple items 22 stored in respective bins 24, in accordance with an embodiment of the present invention. As described hereinbelow, each bin 24 references a region in distribution center 22 where the respective item is stored.

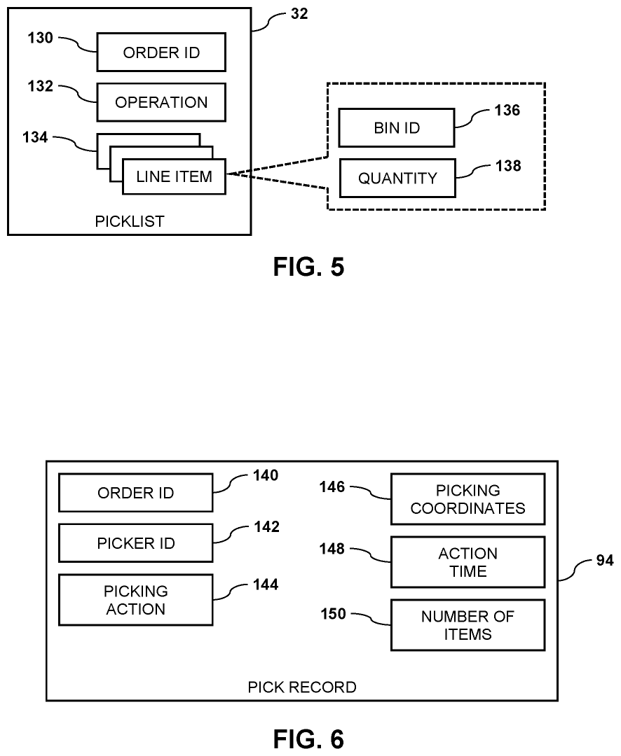

In the configuration shown in FIG. 1, distribution center 20 also comprises a plurality of video cameras 26 and an order picking workstation 28 that are all coupled to a verification engine 30. In embodiment described herein, workstation 28 is configured to generate picklists 32 that are described in the description referencing FIG. 5 hereinbelow.

Video cameras 26 have respective fields of view (FOV) 34 and are configured to capture images at shutter speeds (i.e., frames per second) that enable a given video camera 26 to generate video segments 36 (i.e., recordings) that capture “motions” of an individual 38 (also referred to herein as picker 38) in its respective FOV 34. Video segments 36 are typically stored in verification engine 30. Video cameras 26 are typically positioned in distribution center 20 so that the combined FOVs 34 of all video cameras 26 encompass all bins 24.

In some embodiments, video cameras 26 may be mounted on the ceiling of distribution center so as to provide top-down FOVs 34 of a floor 40 of distribution center 20. Additionally or alternatively, video cameras 26 may be positioned so as to provide side (or angled) FOVs 34 in distribution center 20.

In embodiments herein, FOVs 34 of adjacent video cameras 26 can overlap so that video segments 34 cover a region of interest 42 in distribution center 20. Region of interest 42 typically comprises an area comprising bins 24 and workstation 28. In some embodiments, video cameras 26 are positioned so that the overlaps comprise overlap regions 44 that can be between 10%-30% (e.g., 10%, 15%, 20%, 25% or 30%) of each FOV 34.

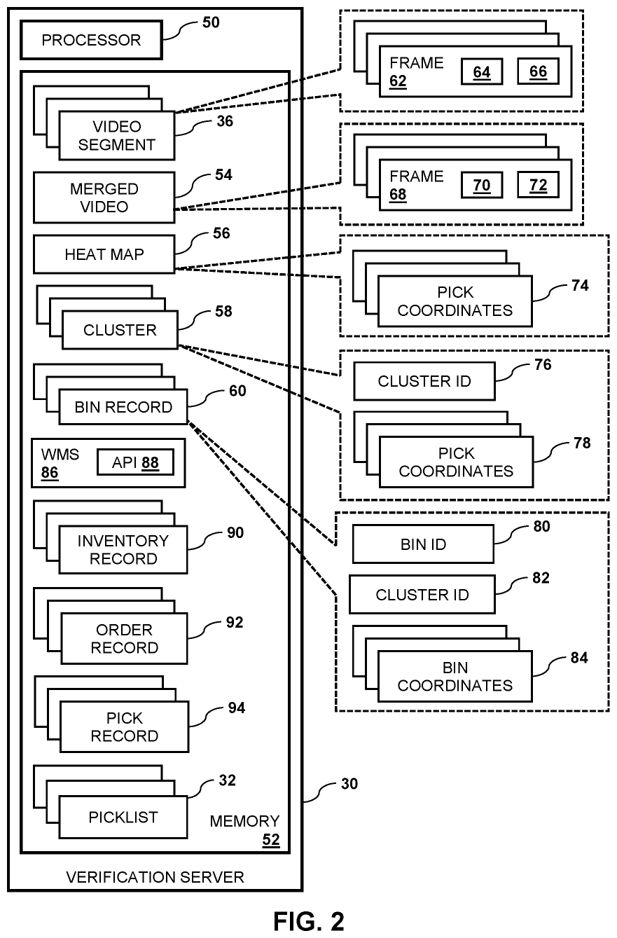

FIG. 2 is a block diagram that shows an example of a configuration of verification engine 30, in accordance with an embodiment of the present invention. In the configuration shown in FIG. 2, verification engine 30 comprises a processor 50 and a memory 52.

In some embodiments, memory 52 comprises multiple video segments 36, a merged video image sequence 54, a heat map 56, multiple cluster records 58 (also referred to herein as clusters 58), and multiple bin records 60 that correspond to bins 24.

Each video segment 36 comprises a set of video segment frames 62, each given video segment frame 62 comprising a video segment image 64 that was captured by a given video camera 26, and a corresponding segment image timestamp 66 indicating a date and a time when the corresponding video segment image was captured. Video segments 36 typically have a one-to-one correspondence with video cameras 26, so that each given video segment 36 comprises the video segment images 64 captured by its corresponding video camera 26.

Merged video image sequence 54 comprises a set of merged video frames 68, each given merged video frame 68 comprising a merged video image 70, and a corresponding merged image timestamp 72 indicating a date and a time when the corresponding video segment image was captured by video cameras 26. As described hereinbelow, processor 50 generates each given merged video image 70 by “stitching” together video segment images 64 from different video segments that have identical timestamps 66.

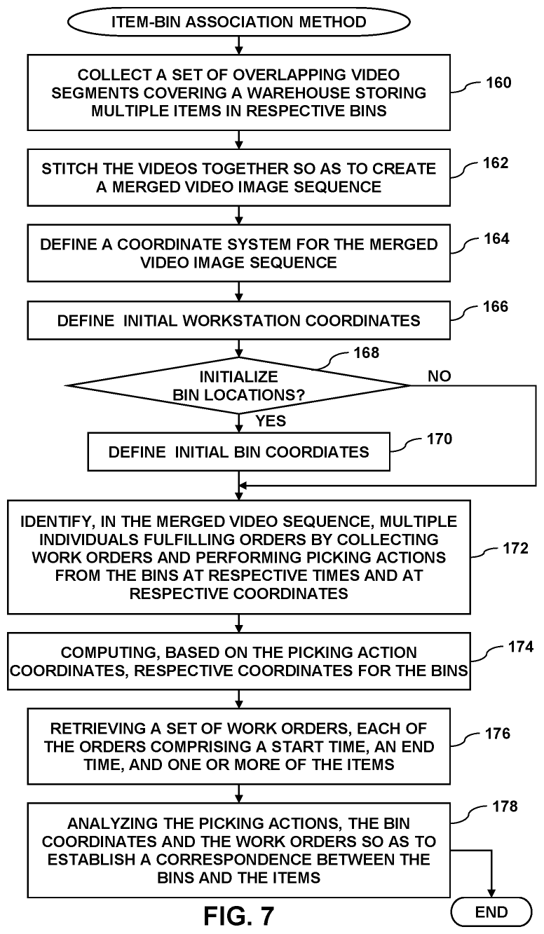

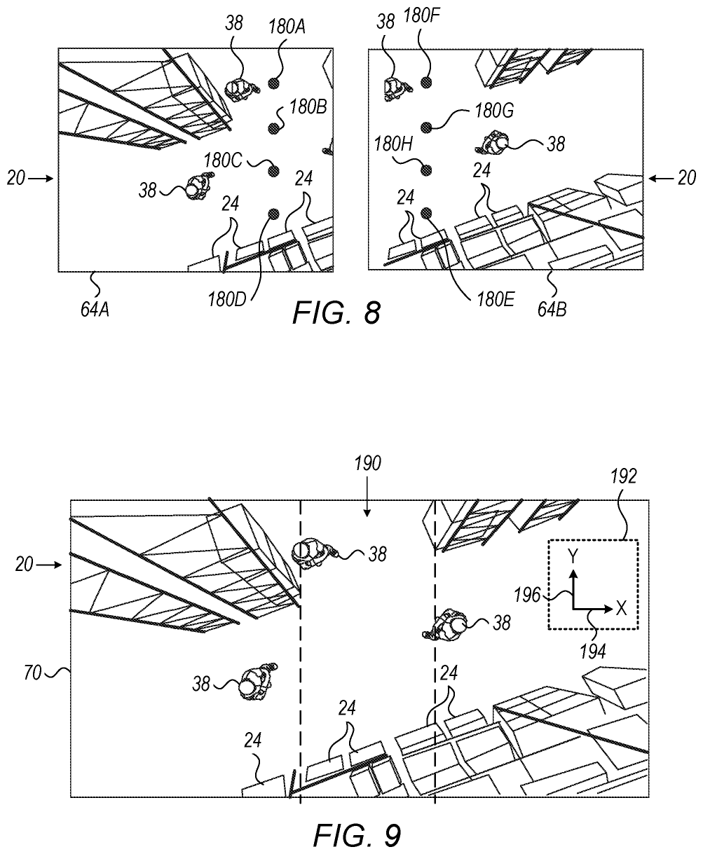

Heat map 56 comprises a set of pick coordinates 74. As described in the description referencing FIG. 9 hereinbelow, processor 50 defines a coordinate system for distribution center 20, and as defined in the description referencing FIG. 7 hereinbelow, the processor can identify pick coordinates 74 (in the coordinate system) of picking actions performed by individuals 38. In embodiments herein, heat map 56 comprises the identified picking coordinates.

As described in the description referencing FIG. 13 hereinbelow, processor 50 can identify clusters of pick coordinates 74 in heat map 56. In embodiments herein, each cluster record 58 can reference a corresponding cluster and can store information such as:
A unique cluster identifier (ID) 76 for the corresponding cluster.
A set of pick coordinates 78 comprising pick coordinates 74 in the corresponding cluster.

Each bin record 60 references a corresponding bin 24 and a corresponding cluster in heat map 56, and can store information such as:
A unique bin ID 80 referencing the corresponding bin in distribution center 20.
A cluster ID 82 referencing the corresponding cluster in heat map 56.
A set of bin coordinates 84 comprising coordinates (I.e., in the defined coordinate system) of a region on floor 40 in distribution center 20

In embodiments of the present invention, memory 52 comprises a warehouse management system (WMS) 86 having an API 88. One example of WMS 86 is ORACLE FUSION CLOUD WAREHOUSE MANAGEMENT™, provided by ORACLE CORPORATION, 2300 Oracle Way, Austin, TX 78741, USA. Processor 50 can execute WMS 86 from memory 52 so as to inventory (i.e., items 22) and a set of orders for the items. In some embodiments, WMS 86 manages respective sets of inventory records 90, order records 92, pick records 94, and picklists 32 that are all stored in memory 52. Each order record 92 references a corresponding order managed/processed by WMS 86.

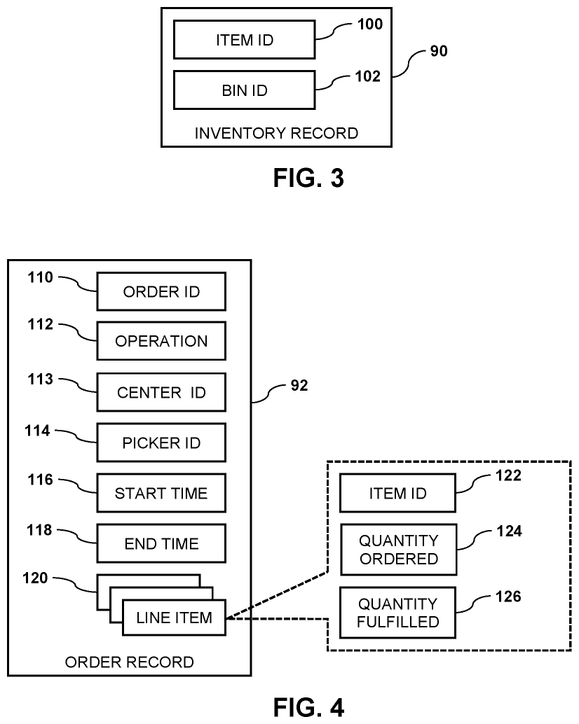

FIG. 3 is a block diagram showing an example of a given inventory record 90, in accordance with an embodiment of the present invention. Each inventory record 90 references a corresponding item 22, and can store information such as:
An item ID 100 referencing the corresponding item 22.
A bin ID 102 comprising a given bin ID 80 referencing a given bin 24 storing the corresponding item 22.

FIG. 4 is a block diagram showing an example of a given order record 92 for a given order, in accordance with an embodiment of the present invention. Each order record 92 can store information such as:
An order ID 110 referencing the corresponding order.
An operation 112 indicating if the given order retrieves (i.e., removes) one or more items 22 from distribution center 20 or restocks (i.e., adding) items in the distribution center.
A center ID 113. In some embodiments, WMS 86 and verification engine 30 may manage orders (i.e., referenced by order IDs 100) that are fulfilled in multiple distribution centers 20 having respective center IDs 113.
A picker ID 114 referencing a given individual 38 that performed picking actions so as to fulfill the given order using embodiments described herein.
A start time 116 referencing a date and time when the given individual started fulfilling the given order. In some embodiments, start time 116 references the date and time when the given individual received the picklist for the given order.
An end time 118 referencing a date and time when the given individual completed fulfilling the given order (i.e., by retrieving or restocking the one or more items in the given order).
One or more line items 120, each given line item 120 comprising:
   An item ID 122 referencing a given item 22.
   A quantity ordered 124 indicating how many of units the given item to either retrieve (i.e., pick) or restock.
   A quantity fulfilled 126 indicating how many units of the given items the given individual retrieved/removed when fulfilling the given order.

FIG. 6 is a block diagram showing an example of a given picklist 32, in accordance with an embodiment of the present invention. In some embodiments, workstation 28 can generate (e.g., print) a given picklist 32 that corresponds to a given order record 92.

Each given picklist 32 can include information such as:
An order ID 130 comprising order ID 110 in the corresponding order record.
An operation 132 comprising operation 112 in the corresponding order record.
One or more line items 134. Each line item 134 references a corresponding line item 120 in the corresponding order record and can store information such as:
   A bin ID 136 referencing the bin storing the item referenced by item ID 122 in the corresponding line item 120.
   A quantity 138 comprising quantity ordered 124 in the corresponding line item 120.

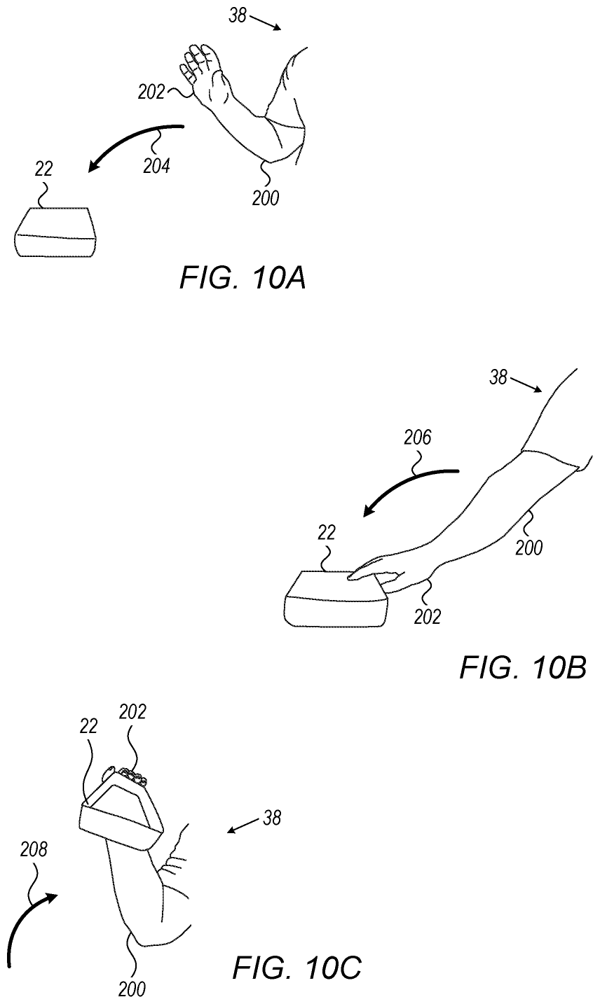

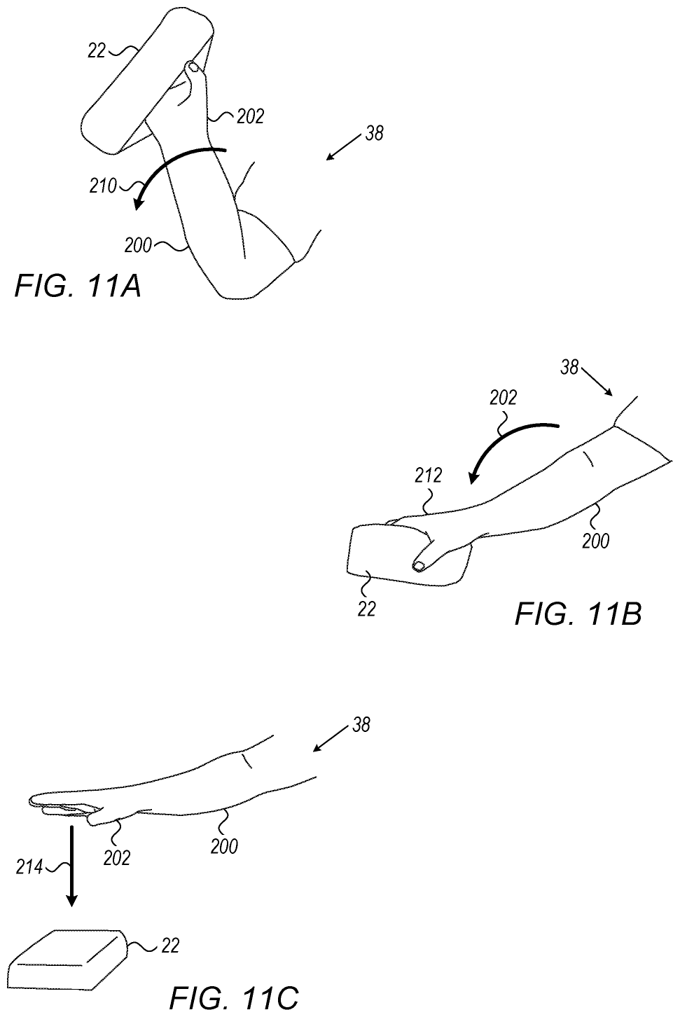

FIG. 6 is a block diagram showing an example of a given pick record 94, in accordance with an embodiment of the present invention. In embodiments herein, processor 50 can generate a new pick record 94 upon detecting a given individual performing a picking action (i.e., retrieving or restocking a given item 22) while fulfilling a given order corresponding to a given order record 92. Picking actions are described in the description referencing FIGS. 10 and 11 hereinbelow.

Each given pick record can store information such as:
An order ID 140 comprising order ID 110 in the corresponding order record.
A picker ID 142 comprising picker ID 114 in the corresponding order record.
A picking action 144 referencing a give picking action. As described in the description referencing FIGS. 10 and 11, the picking actions typically comprise retrieving or restocking one or more given items.
Picking coordinates 146 referencing coordinates in distribution center where processor 50 detected picking action 144.
An action time 148 referencing a date and time of picking action 144.
A number of items 158 indicating how many items the individual referenced by picker ID handled while performing picking action 144.

Processor 50 comprises one or more general-purpose central processing units (CPUs) or special-purpose embedded processors, which are programmed in software or firmware to carry out the functions described herein. This software may be downloaded to verification engine 30 in electronic form, over a network, for example. Additionally or alternatively, the software may be stored on tangible, non-transitory computer-readable media, such as optical, magnetic, or electronic memory media. Further additionally or alternatively, at least some of the functions of processor 50 may be carried out by hard-wired or programmable digital logic circuits.

Examples of memory 52 include dynamic random-access memories, non-volatile random-access memories, hard disk drives and solid-state disk drives.

In some embodiments, tasks described herein performed by processor 50 may be split among multiple physical and/or virtual computing devices. In other embodiments, these tasks may be performed in a managed cloud service.

### Item-Bin Mapping

FIG. 7 is a flow diagram that schematically illustrates a method of mapping items to their respective bins, in accordance with an embodiment of the present invention.

In step 160, processor 50 collects video segments 36 from video cameras 26. To collect a given video segment 36, processor 50 receives a video signal from a given video camera 26, and stores the video signals so as to generate a given video segment 36.

In some embodiments, processor 50 can analyze the received video signal so as to detect whether or not there is any motion in the signal (e.g., a given individual 38 moving within the field of view of the given video camera). At times when processor 50 detects motion in the signal, the processor can store the video signal to the given video segment (i.e., generate the given video segment) at a first frames per second (FPS) speed (e.g., between 15-30 FPS) that captures the motion. At times when processor 50 does not detect any motion in the signal (e.g., no individual 38 is within the FOV of the given video camera), the processor can store (i.e., generate a recording of) the video signal to the given video segment at a second FPS speed slower than the first FPS speed (e.g., between 1-4 FPS).

In step 162 processor 50 stitches video segments 36 together so as to generate merged video image sequence 54. In some embodiments, processor 50 can stitch video segments 36 from a pair of adjacent video cameras 26 video segment frame in 26 by stitching the video segment frames of the video as follows: The pair of adjacent video cameras comprises a first video camera 26 that generates first video segment frames 36 and a second video camera 36 that generates second video segment frames 36, and for each given first video segment frame:
Identify a given second video frame whose timestamp 66 matches timestamp 66 in the first given video frame.
Generate a new merged video image 70 for a new merged video frame 68 by applying a homography algorithm (as described hereinbelow) to the video segment image in the given first video frame and video segment image in the given second video frame.

FIG. 9 is a schematic pictorial illustration showing an example of a pair video segment images 64 (i.e., from different video segments 36) that processor 50 can stitch together, and FIG. 10 is a schematic pictorial illustration of a given merged video image 70 that processor 50 can generate from the pair of video segment images, in accordance with an embodiment of the present invention.

As shown in FIG. 9, each video segment image 64 comprises a set of key points 180. In FIG. 9, video segment images 64 and key points 180 can be differentiated by appending a letter to the identifying numeral, so that the video segment images comprise video segment images 64A-64B, and key points comprise key points 180A-180H.

In the example shown in FIG. 9, video segment image 64A comprises key points 180A-180D and video segment image 64B comprises key points 180E-180H. In some embodiments, processor 50 can use a homography algorithm to generate the given merged video image by matching (i.e., combining images 64A and 64B by aligning) key point 180A to key point 180F, matching key point 180B to key point 180G, matching key point 180° C. to key point 180H, and matching key point 180D to key point 180E.

As shown in FIG. 10, the given merged video image comprises an overlap region 190 that comprises a region of distribution center 20 that is shared by video segment images 64A and 64B.

In step 164, processor 50 defines coordinate system 192 for merged video image sequence 54 that covers workstation 28 and all bins 24 in distribution center 20. In the example shown in FIG. 10, coordinate system 192 is a two-dimensional coordinate system comprising an X-axis 194 and a Y-axis 196. In embodiments where additional video cameras have side FOVs 34 (i.e., in addition to the top-down FOV 34 shown in FIGS. 9 and 10), coordinate system 192 may comprise an additional axis so that the coordinate system is three-dimensional.

As explained hereinbelow, processor 50 tracks individuals 38, and tracks their actions so as enable computing respective locations of bins 24 and workstation 28. In embodiments herein, the location of workstation 28 may be referred to as workstation bin 24. Likewise, bins 24 storing items 22 may also be referred to as item bins 24.

In step 166, processor 50 receives coordinates for workstation 28. As described in the description referencing FIG. 14 hereinbelow, these coordinates define a polygon that encompasses workstation 28. In some embodiments, processor 50 can create a given bin record 60 for workstation 28, and then store the received coordinates to bin coordinates 84 in the given bin record. In these embodiments, bin ID 80 in the given bin references workstation 28, and the given bin may be referred to as workstation bin 24.

In some embodiments, processor 50 can receive initial sets of bin coordinates 84 for one or more bins 24. In these embodiments, processor 50 can use these coordinates to define polygons that encompass the one or more bins 24, as described hereinbelow.

In step 168, if processor 50 receives initial sets of coordinates one or more bins 24, then in step 170, the processor defines coordinates for the one or more bins. In one embodiment, the coordinates processor 50 receives for a given bin may comprise coordinates for a polygon that encompasses the given bin. This embodiment is shown in FIG. 14, as described hereinbelow. In Upon receiving the coordinates for the given bin processor 50 can store the received coordinates to bin coordinates 84 in the bin record whose respective bin ID 80 references the given bin.

In embodiments herein, processor 50 computes bin coordinates 84 for the bins, and identifies which items 22 are stored in which bins 24 by analyzing, in merged video image sequence 54, individuals 38 fulfilling a set of first work orders corresponding to a first set of order records 92. In these embodiments, processor 50 prints, on workstation 28, picklists 32 for the set of first orders, and tracks the fulfillment of these orders as described hereinbelow.

In step 172, processor 50 analyzes merged video sequence 54 so as to identify multiple individuals 38 picklists 32 and performing picking actions 144 to/from bins 24 at times 148 at picking coordinates 146 so as to fulfill the picklists.

To track the fulfillment of a given picklist 32, processor 50 can perform the following identification steps:

In a first identification step, processor 50 detects that a given individual has collected the given picklist. In some embodiments, processor 50 can detect the given individual accessing workstation 28 (e.g., with a keycard) and generating (i.e., printing) the given worklist. Since the given individual is in close proximity to workstation 28 when collecting the given picklist, processor 50 can identify the given individual, since the current coordinates of the given individual is within bin coordinates 84 for the bin record referencing workstation 28.

Upon detecting the given individual generating (i.e., collecting) the given picklist, processor 50 can retrieve the order record whose order ID 110 matches order ID 130 in the given picklist and perform the following:
Store, to the retrieved order record, an ID for the given individual to picker ID 114.
Identify, based on timestamps 72, a date and time when the given individual collected the given picklist, and store the identified date and time to start time 116 in the retrieved order record.

In embodiments herein each pair of a given order record comprising a given order ID 110 and the corresponding picklist 32 whose order ID 130 matching the given order ID may be referred to herein collectively as a given work order.

In a second identification step, processor 50 can then track the given individual as the given individual moves within warehouse 20 and performs picking actions while fulfilling the given picklist.

FIGS. 10A-10C, also referred to herein collectively as FIG. 10 are pictorial illustrations of a first picking action comprising removing one or more items 22 from a given bin 24, in accordance with an embodiment of the present invention. In FIG. 10 (and in FIG. 11, as described hereinbelow), these motions are performed by a given arm 200 and a given hand (i.e., of the given arm) of the given individual. In FIG. 10:
FIG. 10A shows a motion 204 of hand 202 reaching for a given item 22.
FIG. 10B shows a motion 206 of hand 202 grabbing the given item.
FIG. 10C shows a motion 208 of hand 202 holding the given item 22 and moving away from the given bin where the hand grabbed the given item.

In some embodiments, the picking action described in FIGS. 10A-10C may comprise a given individual 38 collecting a given picklist 32 from workstation 28.

FIGS. 11A-11C, also referred to herein collectively as FIG. 1 are pictorial illustrations of a second picking action comprising restocking one or more items 22 to a given bin 24, in accordance with an embodiment of the present invention. In FIG. 10:
FIG. 11A shows a motion 210 of hand 202 holding a given item 22 and reaching for the given bin.
FIG. 11B shows a motion 212 of hand 202 positioning the given item over the given bin.
FIG. 10C shows a motion 214 of hand 202 releasing the given item 22 so that the given item drops into the given bin.

For purposes of visual simplicity, FIGS. 10 and 11 show hand 202 holding a single item 22. In some embodiments, processor 50 can detect, by analyzing merged video images 70 in merged video image sequence 54, that the hand holding more than one item 22. In these embodiments, processor 50 can identify how many items hand 202 is holding.

Additionally, for purposes of visual simplicity, FIGS. 10 and 11 show motions 204-208 and 210-214 from a side view, processor 50 identifying these motions from a top-down view is considered to be within the spirit and scope of the present invention.

Upon detecting a given picking action, processor 50 can add a new pick record 94, and populate the new pick record as follows:
Store, to order ID 140, order ID 130 in the picklist being fulfilled by the given individual.
Store an ID of the given individual to picker ID 142.
Identify (X,Y) coordinates (i.e., in coordinate system 192) of the given picking action, and stored the identified coordinates to picking coordinates 146.
Store the identified picking action to picking action 144.
Store a date and a time of the given picking action (i.e., based on timestamps 72) to action time 148.
Identify a quantity of items 22 handled by hand 202 while performing the picking action, and store the identified quantity to number of items 150.

Processor 50 can detect that the given individual has completed fulfilling the given picklist, by receiving a signal (e.g., from workstation 28) indicating the completion. Upon detecting completion of the given picklist, processor 50 can identify a date and time when the processor received the completion signal, and store the identified date and time to end time 118 in the retrieved order record (i.e., whose order ID 110 matches order ID 130 in the given picklist).

In step 174, processor 50 computes, based on the coordinates of the picking actions, respective coordinates for bins 24. To perform step 172, processor 50 can perform the following bin coordinate steps.

In a first bin coordinate step, processor 50 generates heat map 56 by copying picking coordinates 146 (collected while performing step 170, as described supra) to pick coordinates 74.

In a second bin coordinate step, processor 50 can use a clustering algorithm (e.g., k-means clustering) so as to generate clusters 58. In some embodiments clusters 58 comprise disjoint subsets of picking coordinates 146, and for each given cluster 58, processor 50 copies the respective disjoint subset of pick coordinates 74 to pick coordinates 78 in the given cluster.

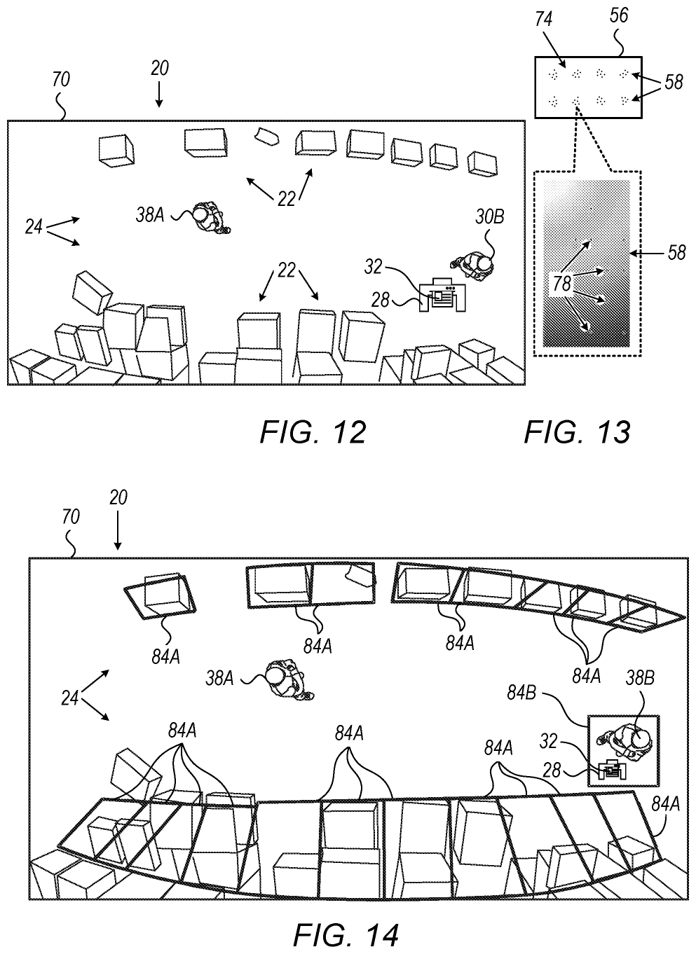

FIG. 12 is a pictorial illustration of a video segment showing individuals 38 fulfilling orders (i.e., as described in the description referencing step 172 hereinabove), and FIG. 13 is a schematic pictorial illustration of heat map 56 generated from picking actions performed by the individuals, in accordance with an embodiment of the present invention.

As shown in FIG. 13, heat map 56 comprises a set of pick coordinates 74 that are grouped into clusters 58. FIG. 13 also shows an exploded view of a given cluster 58 showing pick coordinates 78 in the given cluster.

In embodiments herein, clusters 58 in heat map 56 correspond to bins 24. Therefore, for each given cluster 58, processor 50 can define bin coordinates 84 for bins 24 as follows:
Add a new item bin record 60.
Generate a unique bin ID 80 in the new bin record.
Store a reference to the given cluster to cluster ID1 82 in the new bin record.
For pick coordinates 78 in the given cluster:
   Processor 50 can expand each pick coordinate 78 (transforming each pick coordinate 78 into a 7×7 array) so as to generate a binary image.
   Processor 50 can apply a convex function to the binary image (e.g., the function convexHull in https://learnopencv.com/convex-hull-using-opencv-in-python-and-c/) so as to compute bin coordinates 84 (i.e., for the given bin) that define bin boundaries. In some embodiments, the bin boundaries define a polygon.

FIG. 14 is a pictorial illustration showing bin coordinates 84 that processor 50 can compute based on the heat map 56, in accordance with an embodiment of the present invention. In FIG. 14, bin coordinates 84 can be differentiated by appending a letter to the identifying numeral, so that the bin coordinates comprise bin coordinates 84A for item bin records 60 and bin coordinates 84B for workstation bin 60.

While FIG. 14 shows bin coordinates 84 defining four-sided polygons, using bin coordinates to define polygons with different numbers (e.g., 3, 4, 5, 6, 7 . . . ) of sides is considered to be within the spirit and scope of the present invention.

In step 176, processor 50 retrieves the work orders (i.e., the order records and the corresponding pick tickets) processed in step 172.

Finally in step 178, processor 50 analyzes the picking actions (described in the description referencing step 172 hereinabove), and the retrieved work orders so as to establish a correspondence between bin IDs 80 referencing bins 24 and items 22, and the method ends. Establishing the correspondence may be also be referred to as mapping bin IDs 80 to items 22.

Upon establishing the correspondence, for each given bin ID 80 in bin records 60, processor 50 can generate a new inventory record 90, store the given bin ID 80 to bin ID 102 in the new inventory record, and store an identifier referencing the corresponding item 22 to item ID 100 in the new inventory record.

In some embodiments, processor 50 can use a voting algorithm (e.g., the Boyer-Moore majority voting algorithm) to compute the correspondence between bins 24 and items 22. As a simple example:
Order O1 comprises items I1 and I2.
Order O2 comprises items I2 and I3.
Processor 50 detects items from order O1 were picked from bins B1 and B2.
Processor 50 detects items from order O2 were picked from bins B2 and B3.
Since both orders had only item B2 in common, and processor detected picking actions for both orders at bin B2, the processor can associate bin B2 with item I2.

Returning to step 168, if processor 50 does not receive initial sets of coordinates for workstation 28 or one or more bins 24, then the method continues with step 172.

### Order Verification

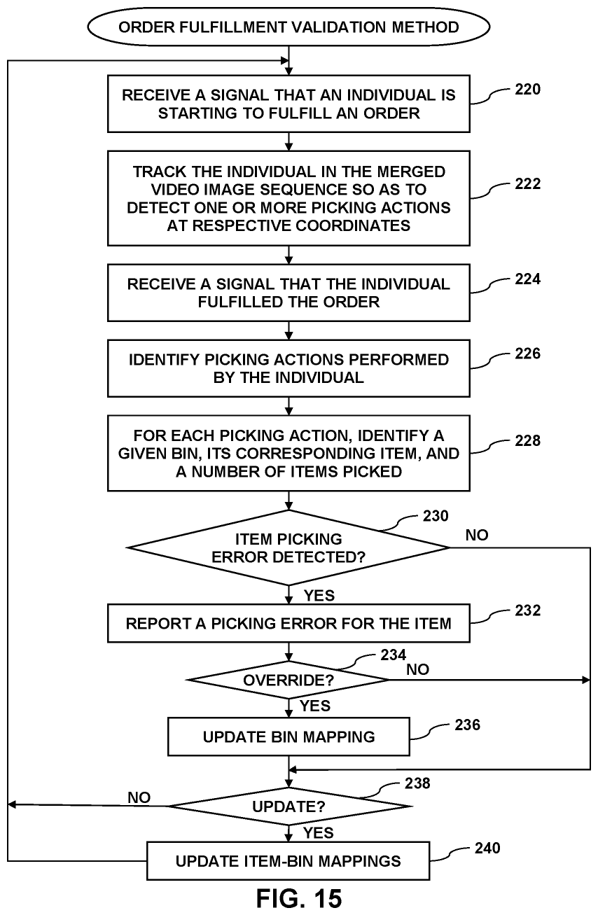

FIG. 15 is a flow diagram that schematically illustrates a method of verifying picking actions performed by individuals while processing additional work orders, in accordance with an embodiment of the present invention.

In step 220, using embodiments described hereinabove, processor 50 receives a signal indicating that a given individual is initiating fulfillment of a new work order comprising a given order record 92 and the corresponding picklist 32.

In step 222, using embodiments described hereinabove, processor 50 analyzes merged video image sequence 54 so as to track the given individual and to identify the given individual performing picking actions. Upon detecting a given picking action and generating and populating the corresponding pick record 94, processor 50 can update quantity fulfilled 128 for a given item ID 122 (i.e., in the same line item 120) in the given order record with number of items 150 in the corresponding pick record 94 (i.e., based on the mapping of picking coordinates 146 to a given bin 24, and the mapping of the given bin to a given item 22).

In step 224, using embodiments described hereinabove, processor 50 receives a signal indicating that the given individual completed fulfilling the new work order. In alternative embodiment, processor 50 can detect fulfillment of the order upon detecting that each given quantity ordered 124 in the given order record matches the corresponding quantity fulfilled 128.

In step 226, using embodiments described hereinabove, processor 50 identifies picking actions performed by the given individual while fulfilling the new work order.

In step 228, using embodiments described hereinabove, processor 50 analyzes the identified picking actions so as to identify, for each given picking action, a given bin 24, the corresponding item 22, and a number of items picked. Upon completing the analysis, processor 50 can detect whether or not the given individual performed picking errors while fulfilling the new work order. Common errors include picking one or more items 22 from the wrong bin 24, or picking an incorrect number of a given item 22.

In step 230, if processor 50 detects a picking error, then in step 232, the processor can send, to the given individual, an alert (e.g., via workstation 28) comprising details of the picking error.

In step 234, if processor 50 receives a picking error override (e.g., a signal) for the picking error, then in step 236, using embodiments described hereinabove, the processor can update the bin to items mapping based on the coordinates of the picking actions that the processor identified while the given individual fulfilled the new work order.

For example, the new work order comprises item//that is currently mapped to bin B1, processor 50 detects that the given individual performed a picking action at the coordinates for bin B2, and generates an alert in response to the error. If processor 50 receives an override for the alert, this could mean that item//is now stocked in bin B2.

In step 238, processor 50 detects if it is time to update the bin to item mappings, based on the coordinates for picking actions the processor detects while individuals fulfill the additional work orders. For example, processor 50 can use embodiments described hereinabove to update the bin to item mappings on a daily, weekly or monthly basis.

If processor 50 detects that it is time to update the bin to item mappings, then in step 240, the processor uses embodiments described hereinabove to update the bin to item mappings, and the method continues with step 220.

Returning to step 238, if processor 50 does not detect that it is time to update the bin to item mappings, then the method continues with step 220.

Returning to step 234, if processor 50 does not receive an override, then the message continues with step 238.

Returning to step 230, if processor 50 does not detect any picking errors, then the method continues with step 238.

Embodiments described supra described picking actions that either retrieved or restocked items 22. An additional picking action may comprise dropping one or more of a given item 22 (i.e., outside the coordinates for the bin mapped to the given item). If processor 50 detects a drop picking action, the processor can update number of items 150 in the pick record corresponding to the drop pick action, which the processor can use to update the appropriate quantity fulfilled 128 in a given order record 92.

Additionally, while embodiments described hereinabove describe processor 50 detecting individuals (i.e., humans) performing picking actions in distribution center 20, detecting picking actions performed by other types of entities (e.g., forklifts) is considered to be within the spirit and scope of the present invention.

Furthermore, while embodiments describe hereinabove describe individuals interacting with workstation 28 so as to collect picklists 32, and indicating start and end times for work orders, using a portable computing device (e.g., a tablet computer) for these purposes (e.g., present the picklists on the tablet) is considered to be within the spirit and scope of the present invention.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
collecting a set of overlapping video segments that cover a warehouse storing multiple items in respective bins;
stitching together the video segments so as to generate a merged video image sequence in a coordinate system of the warehouse;
identifying, in the merged video image sequence, multiple individuals performing picking actions from different ones of the bins at respective coordinates in the coordinate system;
computing, based on the merged video image sequence, respective coordinates in the coordinate system of the bins from which the picking actions were performed;
retrieving, from a warehouse management system, a set of first work orders, each of the first work orders performed by a given individual and comprising one or more of the items;
analyzing, by a processor, the picking actions, the coordinates of the bins, and the first work orders so as to establish a correspondence between the bins and the items; and
applying the correspondence in verifying execution of second work orders performed subsequent to performance of the set of first work orders.

2. The method according to claim 1, wherein the video cameras have respective fields of view (FOV), and where the fields of view of pairs of the cameras that are adjacent to one another have an overlap between 10% and 30%.

3. The method according to claim 2, wherein the video segments comprise respective video segment frames with corresponding timestamps, wherein the merged video sequence comprises merged videoframes, and wherein stitching together the video segments comprises identifying a first video segment frame from a first video camera in a given pair of the cameras, identifying a second video segment frame from a second video camera in the given pair of the cameras having an identical timestamp to first video segment frame, and applying a homography algorithm to the identified video segment frames so as to generate a given merged video frame.

4. The method according to claim 1, wherein collecting a given video segment comprises receiving a video signal, generating, in response to receiving the signal, the given video segment at a first frames per second (FPS) upon detect motion in the video signal, and generating the given video segment at a second FPS lower than the first FPS upon not detect motion in the video signal.

5. The method according to claim 1, wherein a given picking action comprises retrieving one or more given items.

6. The method according to claim 1, wherein a given picking action comprises restocking one or more given items.

7. The method according to claim 1, wherein a given picking action comprises dropping one or more given items.

8. The method according to claim 1, wherein computing the respective coordinates of the bins comprises generating a heat map of the coordinates of the picking action, and detecting, clusters of the coordinates in the heat map, wherein the clusters correspond to the bins.

9. The method according to claim 8, wherein generating the heat map comprises applying a clustering algorithm to the coordinates of the picking action so as to generate the detected clusters.

10. The method according to claim 8, wherein computing the respective coordinates of a given bin comprises applying a convex function to the coordinates in the corresponding cluster.

11. The method according to claim 1, wherein establishing the correspondence between the bins and the items comprises applying a majority voting algorithm to the picking actions, the coordinates of the bins, and the first work orders.

12. The method according to claim 1, wherein verifying execution of a given second work order comprises generating an alert upon detecting, based on the established correspondence, a picking error for a given item in the work order.

13. The method according to claim 12, and further comprising updating the corresponding bin for the given item upon receiving an override for the alert.

14. The method according to claim 1, wherein the merged video image sequence covers all the bins.

15. The method according to claim 1, wherein a given bin comprises a workstation configured to generate the work orders.

16. The method according to claim 15, wherein a given picking action comprises retrieving a given work order from the workstation.

17. An apparatus, comprising:
a memory; and
a processor configured:
to collect a set of overlapping video segments that cover a warehouse storing multiple items in respective bins,
to stitching together the video segments so as to generate, in the memory, a merged video image sequence in a coordinate system of the warehouse,
to identify, in the merged video image sequence, multiple individuals performing picking actions from different ones of the bins at respective coordinates in the coordinate system, to compute, based on the merged video image sequence, respective coordinates in the coordinate system of the bins from which the picking actions were performed,
to retrieve, from a warehouse management system, a set of first work orders, each of the first work orders performed by a given and comprising one or more of the items,
to analyze the picking actions, the coordinates of the bins, and the first work orders so as to establish a correspondence between the bins and the items, and
to apply the correspondence in verifying execution of second work orders performed subsequent to performance of the set of first work orders.

18. A computer software product, the product comprising a non-transitory computer-readable medium, in which program instructions are stored, which instructions, when read by a computer, cause the computer:
to collect a set of overlapping video segments that cover a warehouse storing multiple items in respective bins;
to stitch together the video segments so as to generate a merged video image sequence in a coordinate system of the warehouse;
to identify, in the merged video image sequence, multiple individuals performing picking actions from different ones of the bins at respective coordinates in the coordinate system;
to compute, based on the merged video image sequence, respective coordinates in the coordinate system of the bins from which the picking actions were performed;
to retrieve, from a warehouse management system, a set of first work orders, each of the first work orders performed by a given and comprising one or more of the items;
to analyze the picking actions, the coordinates of the bins, and the first work orders so as to establish a correspondence between the bins and the items; and
to apply the correspondence in verifying execution of second work orders performed subsequent to performance of the set of first work orders.
